(19) United States
(12) Patent Application Publication
(10) Pub. No.: US 2007/0171476 A1
(43) Pub. Date: Jul. 26, 2007

(54) Halftone dot conversion apparatus, Halftone dot conversion program storage medium, and image forming apparatus

(75) Inventor: Makoto Sugizaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/652,509

(22) Filed: Jan. 12, 2007

(30) Foreign Application Priority Data
Jan. 25, 2006 (JP) 2006-016170

(51) Int. Cl. H04N 1/405

(52) U.S. Cl. 358/3.06

(57) ABSTRACT

A halftone dot conversion apparatus converts tone image data representative of an image with tone values into halftone dot image data representative of the image with halftone dots having sizes according to the tone values. This apparatus comprises: a scene discrimination section that discriminates a scene corresponding to the image from among two or more sorts of scenes; a halftone dot definition selecting section that selects a halftone dot definition according to the scene discriminated by the scene discrimination section from among two or more halftone dot definitions defining mutually different sort of halftone dot; and a halftone dot conversion section that converts the tone image data into the halftone dot image data using the halftone dot definition selected by the halftone dot definition selecting section.

### BACKGROUND OF THE INVENTION

1. Field of the Invention

The present invention relates to a halftone dot conversion apparatus that converts tone image data representative of an image with tone values into dot image data in which the image is represented by halftone dots of a drawing area according to the tone values, a halftone dot conversion program storage medium storing a halftone dot conversion program, and an image forming apparatus.

2. Description of the Related Art

In the print field, as a technique for expressing an original image on a recording paper, there is generally adopted a technique for forming on a recording paper a halftone dot image represented by halftone dots in which gradations of the original image are regularly arranged. According to the technique as mentioned above, first of all, there is designed a halftone dot definition that defines the direction of the row of the halftone dot, the interval between the halftone dots of the row of the halftone dot, and the size of the halftone dot associated with the gradation for instance. In the print field, the halftone dot definition is generally addressed as a screen. The designed halftone dot definition is used for a halftone dot conversion apparatus to convert the tone image data representative of an original image with tone values into dot image data in which the image is represented by halftone dots each having a size according to the associated tone value. The dot image data, which is converted by the halftone dot conversion apparatus, is used to form by a plate making machine a dot-like shaped ink receptor portion and a non-ink receptor portion into an original plate, so that there is formed a printing plate where the original image is expressed by the halftone dot. In addition, by a printing machine, ink adheres to the ink receptor portion of the printing plate and the adhered ink is transferred to a recording paper, so that the halftone dot image is formed on the recording paper.

For instance, when the halftone dot image formed on a recording paper is a color image, the halftone dot definition set (screen set), which consists of four halftone dot definitions used for each plate of C(cyan) plate, M(magenta) plate, Y(yellow) plate, and K (black) plate, is prepared beforehand. This prepared halftone dot definition set is used to form a printing plate on each color. Ink is adheres to the ink receipt receptor portion of the printing plate, the adhered ink is transferred to a recording paper, and ink of each color is overlapped, so that a halftone dot image expressed by a color is formed on the recording paper.

In the event that the halftone dot image formed on a recording paper is a monochromatic image, usually, there is prepared a single halftone dot definition, and the single halftone dot definition is used to form a K-plate of halftone dot image on a recording paper. However, the halftone dot image, which is formed with the single halftone dot definition, involves a defect that the lack of the print density stands out, and it becomes insipid finished easily. As a method of supplementing this defect, there is a method of forming a halftone dot image of the black and white of suitable finish in such a way that two or more halftone dot definitions are prepared, the machine plates of two or more K-plates are created by the use of each those two or more halftone dot definitions, and the halftone dot images of K-plates associated with individual machine plates are overlapped on a recording paper.

However, when two or more halftone dot definitions (screen) are used to form a halftone dot image on a recording paper even if the halftone dot image is expressed either by black and white, or by the color as stated above, the row of the halftone dot defined by a certain halftone dot definition and the row of the halftone dot defined by other halftone dot definition are overlapped on a recording paper. Therefore, a small angle formed by overlapping of the rows of the halftone dots with one another may cause interference between the rows of the halftone dots, and thereby generating the moiré.

In general, the halftone dots defined by one halftone dot definition are arranged in two directions perpendicularly. Therefore, when the direction of the row of the halftone dot is expressed at the angle (screen angle) that the row does between prescribed reference axes, the value where the angle of the screen can be taken substantially reaches the value between 0 degrees and 90 degrees.

By the way, when the angle between the rows becomes 30 degrees when the row of two kinds of halftone dots with a mutually different direction of the row is mutually overlapped and formed, the interference of the row and the row of these two kinds of halftone dots is the smallest, and the thing that the moiré is not generated easily is known. In view of the foregoing, it is preferable that the two or more kinds of halftone dots mutually overlapped are designed so that the direction of the row of each halftone dot. (That is, the screen angle) may shift mutually by 30 degrees.

However, as mentioned above, since the range of the angle that can be defined as the direction of the row of the halftone dot is from 0 to 90 substantially degrees, the halftone dot definitions that mutually define each overlapped two or more kind of halftone dot can be designed only up to three in maximums in the preferable states as mentioned above. However, when the above-mentioned color image is formed on a recording paper, four halftone dot definitions corresponding to CMYK 4-plates respectively are needed. Thus, when it is intended to design those four halftone dot definitions in the preferable state as mentioned above, one is left over for the preferable design. Therefore, it is necessary to devise it to design the halftone dot definition set composed of halftone dot definitions for individual CMYK 4-plates so as not to cause the moiré easily.

In general, when the halftone dot definition set (screen set) as mentioned above is designed, it often happens to adopt such a technique that a halftone dot definition each CMK plate is designed so that the angle with which the row of the halftone dot defined in each CMK plate is overlapped with the row and formed may first become 30 degrees respectively about the CMK plate with thick color, and next, the halftone dot definition of Y plate is designed so that the angle of Y plate with light color between rows of the halftone dot defined by Y plate and rows of the halftone dot defined by either of CMK plates may become 15 degrees.

However, according to a halftone dot image wherein a scene is expressed with a strong influence of Y plate, such as a halftone dot image wherein the grass and the leaf are drawn and thus green occupies many, and a halftone dot image wherein man is drawn and thus flesh-color occupies many, the halftone dot of Y version stands out, so that the row of the halftone dot of Y plate and the row of the halftone dot of the CMK plates might interfere each other and the moiré be generated. Moreover, the expected color shade and the color shade of the halftone dot image actually formed on a recording paper might be different from one another depending on the temperature and the humidity of air when printing, so that the moiré might be caused in, for instance, the color shade of Y plate strengthening.

Moreover, in the field of the print, it often happens that the color correction is applied to the image data obtained by reading the original image so that an image is formed on a recording paper with a desirable color shade. When the color shade of Y plate is strongly corrected for instance by such a color correction, the moiré might be caused by the influence of the Y plate.

Therefore, in the field of the print, there is performed a proofreading in such a way that a halftone dot definition set is designed and a printing plate is formed, and thereafter the proof sheet is done with a printer and an operator confirms whether to cause the moiré in the halftone dot image obtained by the proof sheet, and exchanging the halftone dot definition sets when the moiré is caused and evading the generation of the moiré.

Moreover, according to the print by so-called DTP (Desk Top Publishing), there is adopted a method of evading the generation of the moiré in such a way that such a proofreading is done easily in the monitor, and the proof sheet is not actually done.

Moreover, in the field of the print, the halftone dot image might be used as an original image. In this case, in the color correction as mentioned above, it might happen that Y plate in the original image is erroneously emphasized together with characters and the like, and the moiré be generated. Then, as one example of a method of evading such trouble, there is proposed a method in which the object of the color correction is confirmed by distinguishing the halftone dot from the character in the original document, and an appropriate color correction is applied to the halftone dot so that the influence of Y plate is evaded, thereby preventing the moiré being generated (cf. for example, Japanese Patent Application Laid Open Gazette TokuKai. Hei. 9-247481).

Moreover, as other examples of the method of recognizing the object of the color correction, there is proposed a method of recognizing the object in detail for instance like the line drawing image, the halftone dot image, the photograph image, and the image scene, etc. (cf. for example, Japanese Patent Application Laid Open Gazette TokuKai. 2002-27242, Japanese Patent Application Laid Open Gazette TokuKai. 2003-78745, and Japanese Patent Application Laid Open Gazette TokuKai. 2004-349948). It is considered that the combination of the method as mentioned above with the method as disclosed in Japanese Patent Application Laid Open Gazette TokuKai. Hei. 9-247481 makes it possible to more surely avoid the generation of the moiré owing to color correction.

However, the moiré might be generated owing to not only the one by the color correction but also because the original image is an originally strong scene in the color shade of Y plate, as mentioned above. Thus generated moiré cannot be solved by the methods disclosed in the Japanese Patent documents referenced above.

Moreover, according to the method of proofreading and evading the moiré, it involves large scale in work, and in addition, when the moiré is caused in the halftone dot image obtained by the proof sheet, it is necessary to make the printing plate. Thus, this work takes time, labor and the cost.

Moreover, in the event that the moiré is confirmed by the operator on the monitor when proofreading is carried out on the monitor in DTP, it becomes a problem as well as the case where the proof sheet is performed in the point to require labor and the time for preparing the halftone dot definition set where the moiré is not caused easily.

The above mentioned explanation is concerned with the factor that the moiré is generated in the process in which the print is performed, raising an example of the print system. However, this problem is not restricted to the print system as mentioned above. This problem is a problem that occurs similarly on a case where the halftone dot image is formed with an electrophotographic printer in which the toner is for instance fixed on printing paper, and an inkjet printer in which an image is formed by spraying ink on printing paper.

### SUMMARY OF THE INVENTION

In view of the foregoing, it is an object of the present invention to provide a halftone dot conversion apparatus capable of obtaining a preferable halftone dot image that is suppressed in the moiré, saving a cost; a halftone dot conversion program storage medium storing a halftone dot conversion program that causes a computer to operate as such a halftone dot conversion apparatus; and an image forming apparatus using such a halftone dot conversion apparatus.

To achieve the above-mentioned object, the present invention provides a halftone dot conversion apparatus for converting tone image data representative of an image with tone values into halftone dot image data representative of the image with halftone dots having sizes according to the tone values, the halftone dot conversion apparatus comprising:

a scene discrimination section that discriminates a scene corresponding to the image from among two or more sorts of scenes;

a halftone dot definition selecting section that selects a halftone dot definition according to the scene discriminated by the scene discrimination section from among two or more halftone dot definitions defining mutually different sort of halftone dot; and

a halftone dot conversion section that converts the tone image data into the halftone dot image data using the halftone dot definition selected by the halftone dot definition selecting section.

According to the halftone dot conversion apparatus of the present invention, a discrimination of a scene such as sky, sea, and person, for instance is performed in accordance with the original image, and the tone image data of the original image is converted into the halftone dot image data using the halftone dot definition according to the discriminated scene. Therefore, the conversion of each two or more kind of scene from the tone image data to the optimal halftone dot image data is automatically executed by preparing the optimal halftone dot definition in which the moiré etc. are considered for instance beforehand about each two or more kinds of scene. Therefore, according to the halftone dot conversion apparatus of the present invention, it is possible to apply the fine gradation representation to an image suppressing an interference between a row of the halftone dot defined by a certain halftone dot definition and a row of the halftone dot defined by other halftone dot definition, saving time and cost. It is noted that the “halftone dots having sizes according to the tone values” includes a so-called FM halftone dot wherein a gradation is expressed by density of drawing points each all equal and very small in size, and located at random position.

In the halftone dot conversion apparatus according to the present invention as mentioned above, it is preferable that the image is a color image that is represented by a combination of a predetermined number of component colors,

the halftone dot definition selecting section selects a halftone dot definition set according to the scene discriminated by the scene discrimination section from among two or more halftone dot definition sets each consisting of a predetermined number of halftone dot definitions associated with the predetermined number of component colors, and

the halftone dot conversion section converts the tone image data into the halftone dot image data using the halftone dot definitions that constitute the halftone dot definition set selected by the halftone dot definition selecting section.

According to the halftone dot conversion in the color image, there is used the halftone dot definition sets each consisting of a predetermined number of halftone dot definitions to convert the tone image data of the original image into the halftone dot image data, and the quality of the halftone dot image depends on not only individual halftone dot definitions but also the combination of the halftone dot definitions. Therefore, according to the halftone dot conversion apparatus of the present invention as mentioned above, a preparation of the optimal halftone dot definition for each scene makes it possible to automatically design the optimal halftone dot definition, even if the original image is concerned with the color image, and thereby applying the fine gradation representation to an image suppressing an interference between a row of the halftone dot defined by a certain halftone dot definition and a row of the halftone dot defined by other halftone dot definition.

In the halftone dot conversion apparatus according to the present invention as mentioned above, it is preferable that the halftone dot definition selecting section selects the halftone dot definition set according to the scene discriminated by the scene discrimination section from among two or more halftone dot definition sets which commonly include a predetermined number of halftone dot definitions, and are different from one another in an association between the halftone dot definitions and the component colors.

According to the halftone dot conversion apparatus of the present invention as mentioned above, it is possible to select the halftone dot definition in accordance with the scene in such a simple work that one set of the halftone dot definition sets each consisting of a predetermined number of halftone dot definitions is prepared, and an association between the halftone dot definitions and the component colors is exchanged appropriately in accordance with the scene. Moreover, according to such a working, because the halftone dot definition set to be stored in the memory and the like beforehand is sufficient by one, it is possible to contribute to the reduction of the memory capacity. In addition, it is possible to obtain the halftone dot image of the high-resolution of each two or more scenes by preparing the halftone dot definition set composed of the optimal combination in the halftone dot definition.

In the halftone dot conversion apparatus according to the present invention as mentioned above, it is preferable that the halftone dot definition selecting section selects a halftone dot definition according to the scene discriminated by the scene discrimination section from among two or more halftone dot definitions defining halftone dots which are different from one another in an arrangement direction.

According to the halftone dot conversion apparatus of the present invention as mentioned above, it is possible to obtain the halftone dot image of the high-resolution by preparing such a work that on the scene wherein for instance Y-plate is emphasized, as the halftone dot definition of Y-plate, there is prepared beforehand a halftone dot definition that defines halftone dots having such a direction that an interference with halftone dot definitions of other plates is suppressed.

In the halftone dot conversion apparatus according to the halftone dot conversion apparatus of the present invention as mentioned above, it is preferable that the halftone dot definition selecting section selects a halftone dot definition according to the scene discriminated by the scene discrimination section from among two or more halftone dot definitions defining halftone dots which are different from one another in geometry.

It is empirically known that that the easiness of the moiré to be caused depends on not only an angle that is formed by overlapping of the rows of the halftone dots with one another but also the geometry of the halftone dots. Therefore, according to the halftone dot conversion apparatus of the present invention as mentioned above, it is possible to obtain the halftone dot image of the high-resolution by preparing beforehand a halftone dot definition that defines geometry of the optimal halftone dot according to the scene for instance.

To achieve the above-mentioned object, the present invention provides a halftone dot conversion program storage medium for storing a halftone dot conversion program which causes a computer to operate, when the halftone dot conversion program is executed in the computer, as a halftone dot conversion apparatus for converting tone image data representative of an image with tone values into halftone dot image data representative of the image with halftone dots having sizes according to the tone values, the halftone dot conversion apparatus comprising:

a scene discrimination section that discriminates a scene corresponding to the image from among two or more sorts of scenes;

a halftone dot definition selecting section that selects a halftone dot definition according to the scene discriminated by the scene discrimination section from among two or more halftone dot definitions defining mutually different sort of halftone dot; and

a halftone dot conversion section that converts the tone image data into the halftone dot image data using the halftone dot definition selected by the halftone dot definition selecting section.

According to the halftone dot conversion program storage medium of the present invention as mentioned above, it is possible that the computer easily implements the structural elements of the halftone dot conversion apparatus of the present invention.

To achieve the above-mentioned object, the present invention provides an image forming apparatus comprising:

a scene discrimination section that discriminates a scene corresponding to the image from among two or more sorts of scenes;

a halftone dot definition selecting section that selects a halftone dot definition according to the scene discriminated by the scene discrimination section from among two or more halftone dot definitions defining mutually different sort of halftone dot;

a halftone dot conversion section that converts tone image data representative of the image with tone values into the halftone dot image data using the halftone dot definition selected by the halftone dot definition selecting section; and

an output section that outputs an image with halftone dots on a recording sheet in accordance with the halftone dot image data.

According to the image forming apparatus of the present invention as mentioned above, the optimal halftone dot definition is automatically selected in accordance with the individual scene selected by the scene discrimination section, and then the image is formed. Therefore, it possible to form an image which is subjected to the fine gradation representation suppressing an interference between a row of the halftone dot defined by a certain halftone dot definition and a row of the halftone dot defined by other halftone dot definition.

With respect the halftone dot conversion program related to the present invention, and the image forming apparatus of the present invention, only the basic aspects are disclosed here. It is noted that the halftone dot conversion program related to the present invention and the image forming apparatus of the present invention include not only the basic aspects, but also various aspects corresponding to the above-mentioned aspects of the halftone dot conversion apparatus.

With respect to the structural elements such as the scene discrimination section constituting the half tone dot conversion program related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer.

### BRIEF DESCRIPTION OF THE DRAWINGS

FIG. 1 is a perspective view of a printer according to an embodiment of the present invention.

FIG. 2 is a schematic construction view of the printer shown in FIG. 1.

FIG. 3 is a view showing an embodiment of a halftone dot conversion program stored in a halftone dot conversion program storage medium related to the present invention.

FIG. 4 is a functional block diagram of a halftone dot conversion section shown in FIG. 2.

FIG. 5 is a functional construction view of a scene discrimination section shown in FIG. 4.

FIG. 6 is a functional construction view of a scene recognition section shown in FIG. 5.

### DETAILED DESCRIPTION OF PREFERRED EMBODIMENTS

Embodiments of the present invention will be described with reference to the accompanying drawings.

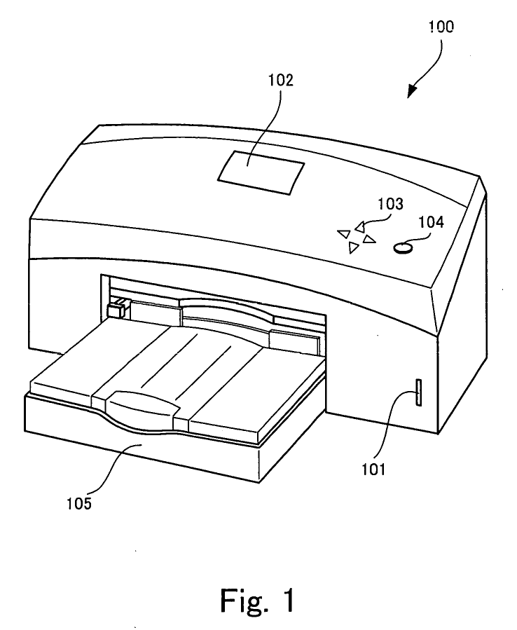

FIG. 1 is a perspective view of a printer according to an embodiment of the present invention.

As shown in FIG. 1, a printer 100 has a sheet tray 105 for accommodating recording papers, and an insertion slot 101 into which a memory stick is inserted, in a front center part of the printer 100. Moreover, LCD panel 102, cross buttons 103, and menu button 104 are prepared for in the upper part of the front side of the printer 100.

The menu button 104 is a button to display various menus on the LCD panel 102, and to decide the selected menu.

The cross buttons 103 serve to select the menu by operation of four buttons of an upper button, a lower button, a left button, and a right button of the cross buttons 103 when the menu screen etc. are displayed on the LCD panel 102.

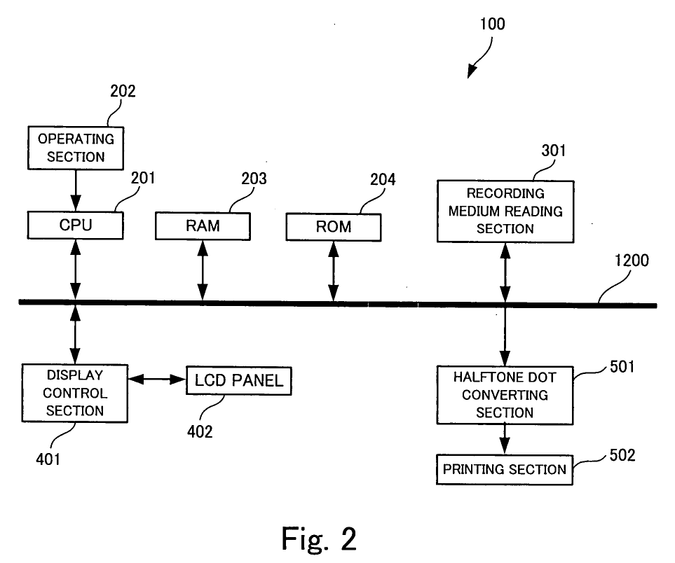

FIG. 2 is a schematic construction view of the printer shown in FIG. 1.

The printer 100 shown in FIG. 2 comprises CPU 201, an operating section 202, RAM 203, ROM 204, a recording medium reading section 301, a display control section 401, LCD panel 402, a halftone dot conversion section 501, and a print section 502.

In FIG. 2, various switches and buttons such as the cross buttons 103 and the menu button 104 shown in FIG. 1 are shown on a batch basis as the operating section 202. Therefore, the display of the menu screen by depression of the menu button 104 for instance is included in the operation of the operating section 202.

The recording medium reading section 301 reads image data that is recorded on the memory stick inserted into the insertion slot 101. An image, which is represented by the thus read image data, is displayed on the LCD panel 402 by the CPU 201.

The printer 100 has the CPU 201 for controlling individual sections of the printer 100, and the ROM 204 that stores a program indicative of a procedure of an operation to be executed by the CPU 201. When the operating section 202 receives an operation, the CPU 201 executes processing according to the operation in accordance with the program. The RAM 203 temporarily stores the program transferred from the ROM 204. The CPU 201 executes the above-mentioned processing through transferring data among individual sections via a bus 1200.

Here, a halftone conversion program is installed in the ROM 204. When the halftone conversion program is activated, the halftone conversion program in the ROM 204 is loaded on the RAM 203 and is executed by the CPU 201, so that the halftone dot conversion section 501 is substantially constructed. The thus substantially constructed halftone dot conversion section 501 corresponds to an embodiment of the halftone dot conversion apparatus of the present invention. The halftone dot conversion section 501 discriminates a scene associated with the input image data read by the recording medium reading section 301, selects a screen set according to the discriminated scene from among a plurality of screen sets, and converts tone image data, wherein an image is represented by tone values, into halftone dot image data, using the selected screen set.

The print section 502 forms an electrostatic latent image on an image carrier surface having a photoconductive layer in accordance with the halftone dot image data which is converted by the halftone dot conversion section 501, and forms a toner image by adhesion of the toner on the electrostatic latent image. The toner image is transferred to a recording paper, and the toner image on the recording paper is fixed on the recording paper to form a halftone dot image. The print section 502 outputs the recording paper on which the halftone dot image is formed.

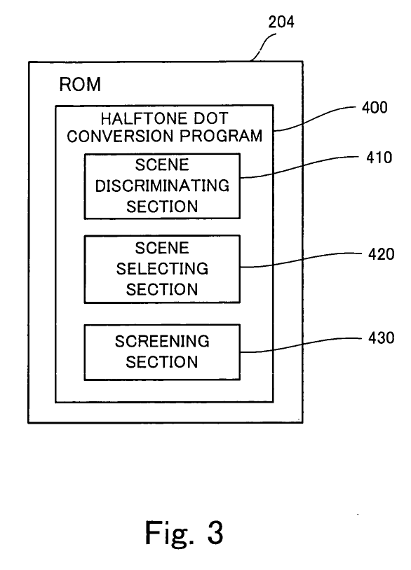

FIG. 3 is a view showing an embodiment of a halftone dot conversion program stored in a halftone dot conversion program storage medium related to the present invention. It is assumed that the halftone dot conversion program is installed in the ROM 204.

FIG. 3 shows, by way of example, the ROM 204 as the recording medium for storing a halftone dot conversion program 400. However, the recording medium for storing the halftone dot conversion program 400 is not restricted to the ROM 204, and it is acceptable that the recording medium is recording medium such as CD-ROM, an optical disk, MO, a flexible disk, and a magnetic tape.

The halftone dot conversion program 400 is executed by the CPU 201, and comprises a scene discriminating section 410, a screen selection section 420, and a screening section 430.

Details of individual elements of the halftone dot conversion program 400 will be described later.

Next, the halftone dot conversion section 501 will be explained in detail.

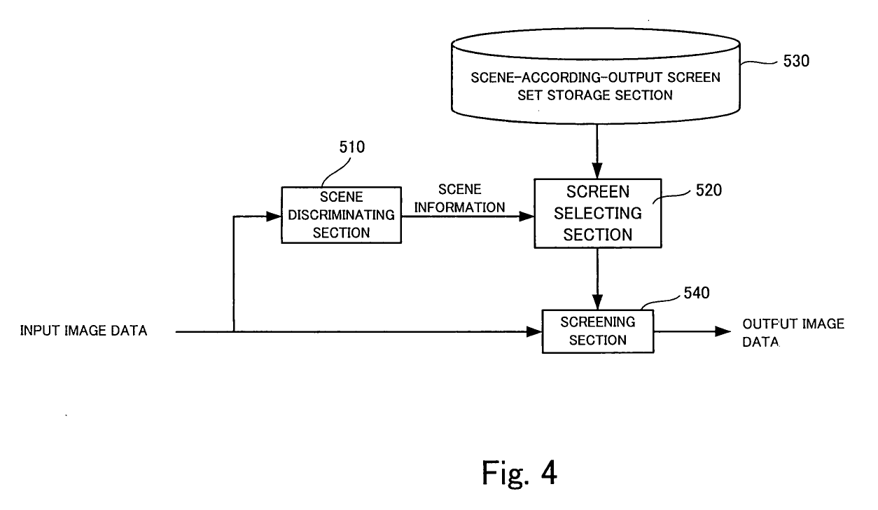

FIG. 4 is a functional block diagram of the halftone dot conversion section shown in FIG. 2.

The halftone dot conversion section 501 is constructed when the halftone dot conversion program 400 shown in FIG. 3 is read from the ROM 204 and then executed.

The halftone dot conversion section 501 shown in FIG. 4 comprises a scene discriminating section 510, a screen selection section 520, a scene-according-output screen set storage section 530, and a screening section 540.

The scene discriminating section 510, the screen selection section 520, and the screening section 540, which are shown in FIG. 4, are constructed by the scene discriminating section 410, the screen selection section 420, and the screening section 430 in the halftone dot conversion program 400, which are shown in FIG. 3, respectively. Hereinafter, there will be explained individual elements of the halftone dot conversion section 501 shown in FIG. 4, and in addition there will be explained individual elements of the halftone dot conversion program 400 shown in FIG. 3. With respect to the scene-according-output screen set storage section 530, it will be explained hereinafter, since it operates in association with individual elements of the halftone dot conversion section 501.

The scene discriminating section 510, the screen selection section 520, and the screening section 540, which are shown in FIG. 4, correspond to examples of the scene discriminating section, the screen selection section, and the screening section, which are referred to in the present invention, respectively.

When input image data is fed to the halftone dot conversion section 501, the input image data is transmitted to the scene discriminating section 510 and the screening section 540.

The scene discriminating section 510 discriminates the scene associated with an image represented by the image data, from among predetermined two or more sorts of scenes, in accordance with Boosting discrimination which will be discriminated later, and outputs scene information indicative of the discriminated scene. The scene information is fed to the screen selection section 520.

The scene-according-output screen set storage section 530 is one storage area of the ROM 204 and stores two or more sorts of screen set beforehand. The screen selection section 520 selects a screen set that is suitable for the scene, from among two or more sorts of screen scenes which are stored in the scene-according-output screen set storage section 530, in accordance with the scene information entered through the scene discriminating section 510. The screen set, which is selected by the screen selection section 520, is fed to the screening section 540. The screening section 540 applies the halftone dot conversion processing to the input image data using the screen set selected by the screen selection section 520.

Next, there will be explained the scene discrimination of images by the scene discriminating section 510. First of all, there will be explained the functional construction of the scene discriminating section 510.

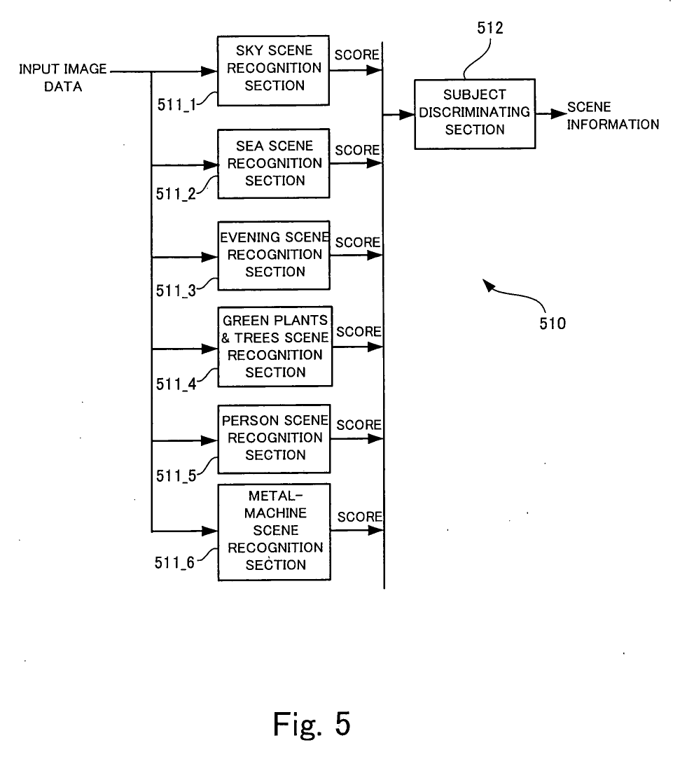

FIG. 5 is a functional construction view of a scene discriminating section shown in FIG. 4.

The scene discriminating section 510 shown in FIG. 5 comprises: six recognition sections 511_1, 511_2, 511_3, 511_4, 511_5, and 511_6, which recognize six sorts of scenes such as sky, sea, evening scene, green trees and plants, person, and metals and machines, respectively; and a subject discriminating section 512 that discriminates a scene corresponding to a scene associated with a subject of the image in accordance with an integration of recognition results in the six recognition sections 511_1, . . . 511_6.

Table 1 defines six sorts of scenes which are recognized by the c.

TABLE 1

| Scenes | Definitions |
|---|---|
| Sky | The one that an image includes a portion |
| | capable of being recognized as blue sky. The |
| | sky of thin clouds is excluded though there |
| | may be the cloud. |
| Sea | It can be recognized that it is taken a |
| | picture in the sea and color-phase of R system |
| | is not included in the subject and is the one |
| | that scene overall is biased to B-G color- |
| | phase. |
| Evening scene | The one that the sun of evening comes out. |
| Green plants & | The one that green plants and trees come out |
| trees | in the majority of image. |
| Person | The one that a person's face comes out as the |
| | main subject. |
| Metals & | The one whose metallic structure of gray basis |
| machines | is subject. |

The six recognition sections 511_1, . . . 511_6 discriminate a scene in a accordance with a rule which can accurately discriminate the scene defined by Table 1 through statistical analysis of image data, but do not discriminate the scene directly using the definition shown in Table 1. The six recognition sections 511_1, . . . 511_6 have a common structure except for a point that rules are different from one another. Here, the common structure will be explained.

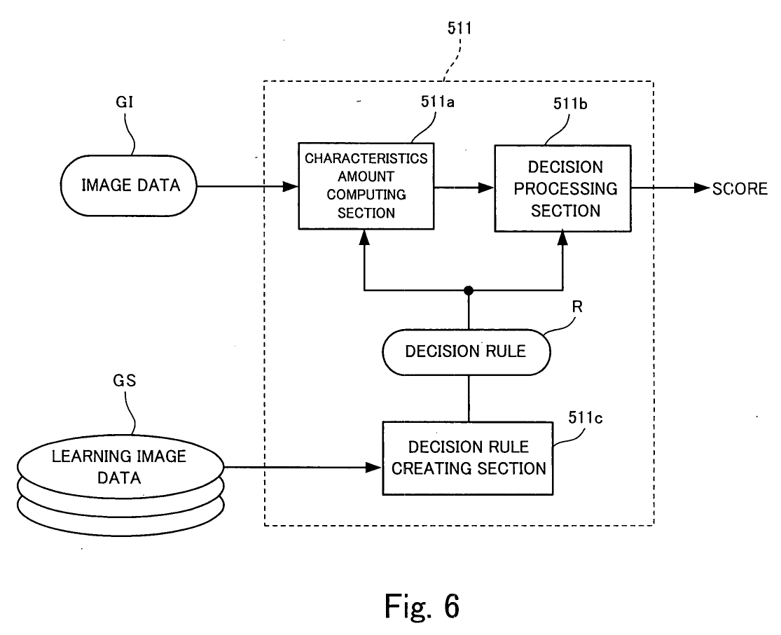

FIG. 6 is a functional construction view of the scene recognition section shown in FIG. 5.

A scene recognition section 511 shown in FIG. 6 analyzes on a hierarchical basis various properties related to colors of an image represented by input image data GI, and determines whether the scene of the image belongs to a scene to be recognized by oneself. The scene recognition section 511 comprises a characteristics amount computing section 511a, a decision processing section 511b, and a decision rule creating section 511c.

The characteristics amount computing section 511a of the scene recognition section 511 performs analysis for the image data GI to compute a characteristics amount representative of the properties related to colors of an image, of a sort according to a decision rule R which will be described later.

The decision processing section 511b of the scene recognition section 511 computes, using the characteristics amount computed by the characteristics amount computing section 511a, a score representative of accuracy that a scene of an image represented by the input image data GI belongs to a scene to be recognized by oneself, in accordance with the decision rule R.

The accuracy of the scene discrimination is decided by the decision rule R which defines a sort of the characteristics amount computed by the characteristics amount computing section 511a and contents of the decision processing to be executed by the decision processing section 511b. According to the present embodiment, a so-called Boosting discrimination technology is used to create a decision rule R with greater accuracy by learning which will be explained later. The decision rule creating section 511c of the scene recognition section 511 creates the decision rule R. The decision rule creating section 511c receives data set GS consisting of two or more sorts of learning image data representative of various scenes of images. The decision rule creating section 511c receives in addition a correct answer which is judged by a person in accordance with the definition of Table 1.

First of all, the decision rule creating section 511c executes the discrimination of the scene using a predetermined initial rule to individual learning image data included in the data set GS, and compares the decision result on the individual learning image data with the correct answer to the learning image data to compute a ratio of correct answer to the data set GS. Next, the decision rule creating section 511c executes an alteration according to the ratio of correct answer to the sort of characteristics amount in the predetermined initial rule and contents of the decision processing. Then, the decision rule creating section 511c executes the decision according to the rule after the alteration to the individual learning image data included in the data set GS, and compares the decision result on the individual learning image data with the correct answer to compute a ratio of correct answer. The decision rule creating section 511c repeatedly executes a series of processing that consists of the alteration of the decision rule, the decision, and the computation of the ratio of correct answer, until the correct answer rate more than prescribed is obtained. Thus, the decision rule R, which is finally obtained, is transmitted from the decision rule creating section 511c to the characteristics amount computing section 511a and the decision processing section 511b. It is known that the scene decision based on such decision rule R becomes the scene decision of high accuracy.

When the scene of the image represented by image data GI to be processed is decided in accordance with the thus determined decision rule R, the scene recognition section 511 can perform the decision with high accuracy to the scene of the image.

When the six recognition sections 511_1, . . . 511_6 shown in FIG. 5 execute the scene decisions explained above, respectively, the six recognition sections 511_1, . . . 511_6 output scores so as to be fed to the subject discriminating section 512.

The subject discriminating section 512 discriminates a scene corresponding to a scene constructed by the subject of the image in accordance with those scores, and outputs scene information representative of the scene. The subject discriminating section 512 prepares discriminant functions J(S1, . . . , S6) wherein the scores Si(i=1, . . . , 6), which are output from the recognition sections 511_1, . . . 511_6, are the argument. The functional values of the discriminant functions J(S1, . . . , S6) are the scene information I, that is, I=J(S1, . . . , S6).

As the discriminant function, for instance, there is considered the function max_index wherein the argument number of the argument indicative of the maximum value of the arguments is the functional value. In this case, the following equation is given.

I=J(S1, . . . , S6)=max_index (S1, . . . , S6)

### Further, as another example of the discriminant function, there is considered a discriminant function where weighted factor αi (i=1, . . . , 6) considering the linear weight on each scene is used, as set forth below.

I=J(S1, . . . , S6)=max_index (α1S1, . . . , α6S6)

### Moreover, there is considered a discriminant equation where weighted factor Φi (i=1, . . . , 6) considering the non-linear weight on each scene is used, as set forth below.

I=J(S1, . . . , S6)=max_index (Φ1(S1), . . . , D6(S6))

The subject discriminating section 512 outputs the scene information I obtained by the above-mentioned discriminant functions. However, in the event that all the scores Si(i=1, . . . , 6) of each scene have fallen below a prescribed lower limit, it is judged that the image doesn't correspond to either of the six sorts of scenes mentioned above, so that the value “0” as the scene information I is outputted.

The scene discriminating section 510 shown in FIG. 4 outputs the scene information in accordance with the above-mentioned processing. The scene information is fed to the screen selection section 520 to select a screen corresponding to the scene represented by the entered scene information I. Here, there will be explained the selection processing that the screen selection section 520 selects the screen corresponding to the scene represented by the entered scene information I from among the screens stored in the scene-according-output screen set storage section 530 shown in FIG. 4.

TABLE 2

| Scenes | Scene-According-Screens |
|---|---|
| Sky | Ordinary Square Screen |
| | (C: 15°, M: 45°, K: 75°, |
| | Y: 0°) |
| Sea | Ordinary Square Screen |
| | (C: 15°, M: 45°, K: 75°, |
| | Y: 0°) |
| Evening scene | Square Screen |
| | (C: 0°, M: 45°, K: 75°, |
| | Y: 15°) |
| Green plants & | Square Screen |
| trees | (C: 15°, M: 45°, K: 0°, |
| | Y: 75°) |
| Person | Elliptical Screen |
| | (C: 15°, M: 45°, K: 0°, |
| | Y: 75°) |
| Metals & machines | FM Screen |
| (Car, Clock) | |

Table 2 shows 6 scenes to be discriminated by the scene discriminating section 510, and screens that define screen angles and the halftone dot geometries in association with those 6 scenes. What is meant by the screen angle is an angle formed between a row of the halftone dot and a prescribed reference axis. Moreover Table 2 shows FM (Frequency Modulation) screen. The FM screen denotes a screen wherein a gradation is expressed by density of drawing points each all equal and very small in size, and located at random position. According to the FM screen, the gradation is expressed by density of drawing points. This feature involves no interference between the row and the row of the halftone dots. Thus, the halftone dot image created by the use of this screen brings about no moiré.

In general, the halftone dots defined by one halftone dot definition are arranged in two directions which are perpendicular to one another. Therefore, when the direction of the row of the halftone dots is expressed at the angle of the screen, the value where the angle of the screen can be taken substantially reaches the value between 0 degrees and 90 degrees. Moreover, it is known that in the event that the rows of two kinds of halftone dots with a mutually different direction of the row are mutually overlapped and formed, when the angle between those rows becomes 30 degrees, the interference of the row and the row of these two kinds of halftone dots is the smallest, and the moiré is not generated easily. Thus, it is preferable that the two or more kind of halftone dot mutually overlapped is designed so that the angle of the screen may shift mutually by 30 degrees. Moreover, the halftone dot is recognized easily and the screen stands out when the angle of the screen becomes 0 degrees. Moreover, it is desirable that the screen where the angle of the screen is defined in 15 degrees is selected for the brightest color, and the screen where the angle of the screen is defined in 45 degrees is selected for the thickest color. In view of the foregoing, in the usual scene where yellow is unremarkable, the screen where the angle of the screen is defined in 45 degrees is selected for K-plate, the screen where the angle of the screen is defined in 15 degrees is selected for C-plate, the screen where the angle of the screen is defined in 75 degrees is selected for M-plate, and the screen where the angle of the screen is defined in 0 degrees is selected for Y-plate. It is believed with those selections that the moiré becomes unremarkable. According to the present embodiment, the set of such a screen is used as a usual screen set.

Moreover, when the halftone dot geometry is selected, there are prepared a Square screen where the shape of the halftone dot has a square shape an Elliptical screen where the shape of the halftone dot has diamond shape. In the usual scene, the Square screen is selected, and in the scene where more fine gradation representation is required, the Elliptical screen is selected.

For instance, it is empirically known that the scenes of the sky and the sea are ones in which blue occupies many, and the halftone dot image wherein these scenes are formed is an image in which yellow is not remarkable. Therefore, these scenes correspond to the usual scene in which yellow is unremarkable. When the scene discriminating section 510 determines the original image to be the scene of the sky and the sea, the shape of the halftone dot is provided for the square shape, and the usual screen set is selected on the set of the screen.

Moreover, it is empirically known that the scene of the evening is a scene in which orange occupies many, and the halftone dot image wherein this scene is formed is an image in which cyan is not remarkable but yellow is remarkable. Therefore, when the scene discriminating section 510 determines the original image to be the scene of the evening, there is selected a screen set having a square halftone dot geometry wherein the C-plate is associated with the screen where the angle of the screen is defined in 0 degrees, the M-plate is associated with the screen where the angle of the screen is defined in 45 degrees, the K-plate is associated with the screen where the angle of the screen is defined in 75 degrees, and the Y-plate is associated with the screen where the angle of the screen is defined in 15 degrees, so that a generation of the moiré due to the influence of the Y-plate is suppressed, and an orange gradation expression becomes rich. The relation between the above-mentioned screen set and the usual screen set resides in the point that the screen for the C-plate and the screen for Y-plate are interchanged.

Moreover, it is empirically known that the scene of the green trees and plants is a scene in which green occupies many, and the halftone dot image wherein this scene is formed is an image in which black is not remarkable but yellow is remarkable. Therefore, when the scene discriminating section 510 determines the original image to be the scene of the green trees and plants, there is selected a screen set having a square halftone dot geometry wherein the C-plate is associated with the screen where the angle of the screen is defined in 15 degrees, the M-plate is associated with the screen where the angle of the screen is defined in 45 degrees, the K-plate is associated with the screen where the angle of the screen is defined in 0 degrees, and the Y-plate is associated with the screen where the angle of the screen is defined in 75 degrees, so that a generation of the moiré due to the influence of the Y-plate is suppressed, and a green gradation expression becomes rich. The relation between the above-mentioned screen set and the usual screen set resides in the point that the screen for the K-plate and the screen for Y-plate are interchanged.

Moreover, it is empirically known that the scene of the person is a scene in which skin color occupies many, and the halftone dot image wherein this scene is formed is an image in which black is not remarkable but yellow is remarkable. Further, a fine gradation representation is required for the person. Therefore, when the scene discriminating section 510 determines the original image to be the scene of the person, there is selected a screen set having a diamond geometry wherein the C-plate is associated with the screen where the angle of the screen is defined in 15 degrees, the M-plate is associated with the screen where the angle of the screen is defined in 45 degrees, the K-plate is associated with the screen where the angle of the screen is defined in 0 degrees, and the Y-plate is associated with the screen where the angle of the screen is defined in 75 degrees, so that a generation of the moiré due to the influence of the Y-plate is suppressed, and a green gradation expression becomes rich. The above-mentioned screen set is different from the screen set for the scene of “green trees and plants” in the halftone dot geometry, although they are the same in the screen angle of individual plates.

When the scene discriminating section 510 determines the original image to be the scene of the metals and machines, there is selected the FM screen in which the image quality is fine, the rich generation is represented, and the moiré is not caused.

When the scene discriminating section 510 determines that the original image is not associated with either of six kinds of scenes, a usual screen set is selected.

As mentioned above, according to the present embodiment shown in FIG. 1, even what scene the original image is concerned with, it is possible to automatically select a screen set composed of screens appropriately combined according to the scene in accordance with the scene distinction. The screen set thus obtained is used in the screening section 540 shown in FIG. 4 to apply the halftone dot conversion to the gradation image data, so that the dot image data suitable for individual scenes can be obtained. The print section 502 shown in FIG. 2 forms the halftone dot image where the moiré is not caused easily, in accordance with the suitable halftone dot image data.

Therefore, according to the present invention, it is possible to omit the work for renewing the printing plate and the work for preparing newly the halftone dot definition set, and thereby obtaining a preferable halftone dot image suppressed in moiré taking no time and cost.

According to the above-mentioned explanation, there is raised the example in which the present invention is applied to a printer. However, the present invention is not restricted to the present embodiment, and it is acceptable that the present invention is applied to a printing system and a copying machine for instance.

As mentioned above, according to the present invention, there are provided a halftone dot conversion apparatus capable of obtaining a preferable halftone dot image that is suppressed in the moiré, saving a cost; a halftone dot conversion program storage medium storing a halftone dot conversion program that causes a computer to operate as such a halftone dot conversion apparatus; and an image forming apparatus such a halftone dot conversion apparatus.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A halftone dot conversion apparatus for converting tone image data representative of an image with tone values into halftone dot image data representative of the image with halftone dots having sizes according to the tone values, the halftone dot conversion apparatus comprising:
a scene discrimination section that discriminates a scene corresponding to the image from among two or more sorts of scenes;
a halftone dot definition selecting section that selects a halftone dot definition according to the scene discriminated by the scene discrimination section from among two or more halftone dot definitions defining mutually different sort of halftone dot; and
a halftone dot conversion section that converts the tone image data into the halftone dot image data using the halftone dot definition selected by the halftone dot definition selecting section.

2. A halftone dot conversion apparatus according to claim 1, wherein the image is a color image that is represented by a combination of a predetermined number of component colors,
the halftone dot definition selecting section selects a halftone dot definition set according to the scene discriminated by the scene discrimination section from among two or more halftone dot definition sets each consisting of a predetermined number of halftone dot definitions associated with the predetermined number of component colors, and
the halftone dot conversion section converts the tone image data into the halftone dot image data using the halftone dot definitions that constitute the halftone dot definition set selected by the halftone dot definition selecting section.

3. A halftone dot conversion apparatus according to claim 2, wherein the halftone dot definition selecting section selects the halftone dot definition set according to the scene discriminated by the scene discrimination section from among two or more halftone dot definition sets which commonly include a predetermined number of halftone dot definitions, and are different from one another in an association between the halftone dot definitions and the component colors.

4. A halftone dot conversion apparatus according to claim 1, wherein the halftone dot definition selecting section selects a halftone dot definition according to the scene discriminated by the scene discrimination section from among two or more halftone dot definitions defining halftone dots which are different from one another in an arrangement direction.

5. A halftone dot conversion apparatus according to claim 1, wherein the halftone dot definition selecting section selects a halftone dot definition according to the scene discriminated by the scene discrimination section from among two or more halftone dot definitions defining halftone dots which are different from one another in geometry.

6. A halftone dot conversion program storage medium for storing a halftone dot conversion program which causes a computer to operate, when the halftone dot conversion program is executed in the computer, as a halftone dot conversion apparatus for converting tone image data representative of an image with tone values into halftone dot image data representative of the image with halftone dots having sizes according to the tone values, the halftone dot conversion apparatus comprising:
a scene discrimination section that discriminates a scene corresponding to the image from among two or more sorts of scenes;
a halftone dot definition selecting section that selects a halftone dot definition according to the scene discriminated by the scene discrimination section from among two or more halftone dot definitions defining mutually different sort of halftone dot; and
a halftone dot conversion section that converts the tone image data into the halftone dot image data using the halftone dot definition selected by the halftone dot definition selecting section.

7. An image forming apparatus comprising:
a scene discrimination section that discriminates a scene corresponding to the image from among two or more sorts of scenes;
a halftone dot definition selecting section that selects a halftone dot definition according to the scene discriminated by the scene discrimination section from among two or more halftone dot definitions defining mutually different sort of halftone dot;
a halftone dot conversion section that converts tone image data representative of the image with tone values into the halftone dot image data using the halftone dot definition selected by the halftone dot definition selecting section; and
an output section that outputs an image with halftone dots on a recording sheet in accordance with the halftone dot image data.
